(19) United States
(12) Patent Application Publication
(10) Pub. No.: US 2011/0031404 A1
(43) Pub. Date: Feb. 10, 2011

(54) APPARATUS AND METHOD FOR SIMULTANEOUSLY GENERATING TERAHERTZ WAVE AND SUPERCONTINUUM, AND SPECTROSCOPY METHOD USING THE SAME

(75) Inventors: Jae Hun KIM, Seoul (KR); Seok LEE, Seoul (KR); Deok Ha WOO, Seoul (KR); Sun Ho KIM, Seoul (KR); Young Tae BYUN, Guri (KR); Shin Geun KIM, Seoul (KR)

Correspondence Address: LRK Patent Law Firm, 1952 Gallows Rd, Suite 200, Vienna, VA, 22182, US

(73) Assignee: KOREA INSTITUTE OF SCIENCE AND TECHNOLOGY, Seoul (KR)

(21) Appl. No.: 12/641,015

(22) Filed: Dec. 17, 2009

(30) Foreign Application Priority Data
Aug. 6, 2009 (KR) 10-2009-0072420

(51) Int. Cl. G01J 5/02; G02F 1/35; G02F 1/355; G02F 1/37

(52) U.S. Cl. 250/341.1; 359/326; 359/328

(57) ABSTRACT

The present invention relates to an apparatus and method for simultaneously generating terahertz wave and supercontinuum, and a spectroscopy method using the apparatus and method, in which terahertz wave and supercontinuum can be efficiently and simultaneously generated by a single device after taking into consideration the problems of conventional methods in which terahertz wave and supercontinuum were generated by separate devices. The apparatus for simultaneously generating terahertz wave and supercontinuum, includes a terahertz wave generation unit for generating a terahertz wave, and a supercontinuum generation unit for generating a supercontinuum based on nonlinear effect, wherein the terahertz wave and the supercontinuum are simultaneously generated using a single input light signal.

### BACKGROUND OF THE INVENTION

1. Field of the Invention

The present invention relates generally to an apparatus and method for simultaneously generating terahertz wave and supercontinuum, and a spectroscopy method using the apparatus and method. More particularly, the present invention relates to an apparatus and method for simultaneously generating terahertz wave and supercontinuum, and a spectroscopy method using the apparatus and method, in which terahertz wave and supercontinuum can be efficiently and simultaneously generated by a single laser source after taking the problems of conventional methods into consideration in which terahertz wave and supercontinuum were generated by two separate devices.

2. Description of the Related Art

Terahertz waves denote signals, which fall within a frequency range from 0.1 to 10 THz, which are equal to a wavelength range from 0.03 to 3 mm. Currently, terahertz waves are widely used in biology, chemistry, national defense, environmental detection, security, and communication, etc. As the generation of coherent terahertz waves (THz waves) becomes possible due to the use of stabilized femtosecond (1 fs=10⁻¹⁵ seconds) optical pulses and the recent excellent results of engineering such as material engineering, new research fields different from the flow of millimeter wave or sub-millimeter wave engineering, originating from previous microwave engineering, or typical far-infrared spectroscopy, have been developed.

Terahertz waves can be generated in such ways that are to emit wideband pulse-shaped terahertz (THz) light from a material excited using an ultra-short pulse laser, to use the acceleration of electrons in a photoconductive antenna, to use a nonlinear effect in electro-optic crystals, or to use plasma oscillation.

An ultra-fast pulse laser light can be radiated onto a GaAs or InP semiconductor which is a photoconductor (so that photonic energy is greater than the band gap of a material), and thus electron-hole pairs are generated. When a bias electric field of ˜10 V/cm is applied to such a semiconductor, free electrons and holes are accelerated, and thus photoelectric current is produced. At this time, the accelerated electrons produce THz light. A THz pulse generation device is configured such that a divided antenna is manufactured on a semiconductor substrate to form switches, and such that, when a dc bias is applied to both ends of the antenna and ultra-fast laser pulses (<100 fs) are condensed onto an antenna gap, electrons cross the gap at high speed, and thus the current of the antenna enables THz pulses to be generated. A THz pulse light source using a photoconductor has, low output power, but generates stabilized and coherent beams. Accordingly, such a THz pulse light source is used in high-resolution Time Domain Spectroscopy (TDS), and exhibits excellent Signal/Noise Ratio (SNR) in THz imaging technology.

The generation of THz light using the nonlinear effect of an electro-optic crystal is intended to generate THz pulses using the nonlinear effect of a crystal such as GaAs or ZnTe produced when an ultra-fast pulse laser radiates light onto such a crystal. That is, the nonlinear effect in which an incident beam having a frequency of ωin is divided into two beams respectively having frequencies of ωout1 and ωout2 is exhibited (ωin=ωout1+ωout2). Frequencies ωout1 and ωout2 undergo into optical rectification process to generate THz light. This method has low efficiency, but is advantageous in that it has a wide bandwidth.

Efficient' THz wave generation methods are divided into methods using optical rectification based on x⁽²⁾ process, and methods using four-wave mixing based on x⁽³⁾ process. THz wave generation methods based on x⁽²⁾ process may include methods using optical media such as Zinc telluride (ZnTe), Cadmium telluride (CdTe), and c-cut Diethylaminosulfur trifluoride (DAST), each having strong x⁽²⁾ characteristics. In addition, methods using gas or liquid are also widely known. When femtosecond optical pulses are propagated into an electro-photo crystal having a high x⁽²⁾ value, THz pulse waves of about 1 cycle are generated while forming a Cerenkov circle, owing to optical rectification. That is, when femtosecond laser pulses are radiated onto the surface of a semiconductor on which a surface electric field is formed, carriers (electrons and holes) excited by the laser are accelerated because of the electric field on the surface of the semiconductor, and thus a current (called ‘surge current’) flows and a THz pulse wave is generated. InP or GaAs is a semiconductor having a large surface electric field. Such a semiconductor simultaneously radiates THz pulse waves generated by the optical rectification of an incident optical pulse obtained based on a secondary nonlinear optical effect occurring near the surface, that is, x⁽²⁾ processing. Further, a representative method based on an x⁽³⁾ process may be a method using air plasma.

When a light signal having a short wavelength is incident on an optical medium such as a photonic crystal fiber, the wavelength of the light signal is greatly widened because of a nonlinear effect. The light signal, the wavelength of which has been widened in this way is called supercontinuum. Such supercontinuum has been implemented using various types of optical media such as various fibers and crystals. Currently, it is well known that supercontinuum in which the wavelength thereof is expanded by more than 1000 nm is easily implemented using a femtosecond laser and an optical fiber or a non-linear optical medium.

Currently, supercontinuum and terahertz waves are widely used in biology, chemistry, national defense, environmental detection, security and communication. All materials have their own wavelength spectra in the ultraviolet (UV), visible, and Infrared (IR) (near-IR, mid-IR, and far-IR) bands. When only a single band is viewed, not many identifiable number of peaks, which are used to distinguish the identity of a material, can be obtained. Therefore, when only a single band is measured, it is very difficult to determine the identity of a relevant material using only the number of unique peaks that the measured material has. Therefore, as the wavelength of a light source used in spectroscopy covers wider or multiple bands, the number of unique peaks increases, and thus the probability of identifying a certain material increases. Therefore, the present invention simultaneously generates multiple bands that can be covered by supercontinuum and terahertz wave, thus conducting spectroscopy in multiple bands using these technologies. In most of the technology, researches on single source including supercontinuum or terahertz wave is currently being conducted, and a research on a technology for simultaneously generating both supercontinuum and terahertz wave is rarely conducted.

### SUMMARY OF THE INVENTION

Accordingly, the present invention has been made in consideration of the problem mentioned above that spectroscopy has not been performed using both IR and terahertz ranges because terahertz wave and supercontinuum were separately generated. An object of the present invention is to provide an apparatus for simultaneously generating a terahertz wave based on x⁽²⁾ process and supercontinuum based on nonlinear effect by only using a single light source, and a method of simultaneously generating supercontinuum and terahertz wave using the apparatus.

Another object of the present invention is to provide an apparatus for simultaneously generating terahertz wave based on x⁽³⁾ process and a supercontinuum based on a nonlinear effect by only using a single light source, and a method of simultaneously generating a supercontinuum and a terahertz wave using the apparatus.

A further object of the present invention is to provide a spectroscopy method, in which a radiation signal having both IR and THz bands, generated by the apparatus and method for simultaneously generating terahertz wave and supercontinuum, is incident on a medium having a unique spectrum, thus simultaneously obtaining the unique spectrum of the medium, desired to be detected, from the two bands of a terahertz wave and a supercontinuum.

In accordance with the first aspect of the present invention to accomplish the above objects, there is provided an apparatus for simultaneously generating supercontinuum and terahertz wave, comprising a focusing lens for allowing an input light signal from a femtosecond laser to be incident thereon, an optical medium for generating terahertz wave based on x⁽²⁾ process, an optical medium based on a nonlinear effect and configured to allow the residual input light signal unused for terahertz wave to be incident thereon, thus generating a supercontinuum, and a collimating lens for outputting both the supercontinuum and terahertz wave.

In accordance with the second aspect of the present invention to accomplish the above objects, there is provided an apparatus for simultaneously generating supercontinuum and terahertz wave, comprising a focusing lens for allowing an input light signal from a femtosecond laser to be incident thereon, the first optical medium for performing second harmonic generation (SHG) to generate 2ω frequency light signal from ω frequency light signal, where 2ω frequency and ω frequency lights are required to generate terahertz wave based on x⁽³⁾ process, generating air plasma by simultaneously focusing the ω frequency light signal and the 2ω frequency light signal, and generating a terahertz wave when the air plasma undergoes a reaction, a second an optical medium based on a nonlinear effect and configured to allow the residual input light signal unused for terahertz wave to be incident thereon, thus generating a supercontinuum, and a collimating lens for outputting both the supercontinuum and the terahertz wave.

In accordance with the third aspect of the present invention to accomplish the above objects, there is provided a method of simultaneously generating supercontinuum and terahertz wave using the apparatus for simultaneously generating supercontinuum and terahertz wave in accordance with the first aspect of the present invention. In accordance with the fourth aspect of the present invention, there is provided a method of simultaneously generating supercontinuum and terahertz wave using the apparatus for simultaneously generating supercontinuum and terahertz wave in accordance with the second aspect of the present invention.

In accordance with the fifth aspect of the present invention, there is provided a spectroscopy method, wherein a radiation signal having both bands of the terahertz wave and the supercontinuum generated by the apparatus for simultaneously generating the terahertz wave and the supercontinuum is incident on a medium having a unique spectrum, and the unique spectrum of the medium desired to be detected is simultaneously obtained in both the bands of the terahertz wave and the supercontinuum.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the schematic construction of an apparatus for simultaneously generating terahertz wave based on x⁽²⁾ process and supercontinuum using a single light signal according to an embodiment of the present invention;

FIG. 2 is a diagram showing the schematic construction of an apparatus for simultaneously generating terahertz wave based on x⁽³⁾ process and supercontinuum using a single light signal according to an embodiment of the present invention;

FIG. 3 is a diagram showing a system expected when technical constructions desired to be implemented in FIG. 1 or 2 are integrated into the system; and

FIG. 4 is a diagram showing applications and effects expected when technical constructions of FIG. 1 or 2 are integrated into the system.

### DESCRIPTION OF THE PREFERRED EMBODIMENTS

Hereinafter, embodiments of the present invention will be described in detail with reference to the attached drawings.

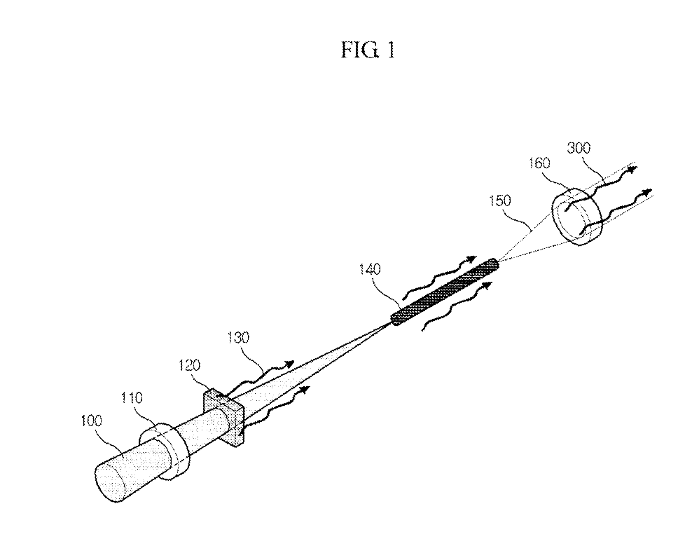

FIG. 1 is a diagram showing an embodiment of the present invention, which illustrates the schematic construction of an apparatus for simultaneously generating terahertz wave based on x⁽²⁾ process and supercontinuum based on nonlinear effect. As shown in FIG. 1, the apparatus for simultaneously generating terahertz wave based on the x⁽²⁾ process and supercontinuum based on nonlinear effect according to the present invention includes a focusing lens 110, a first optical medium 120, a second optical medium 140, and a collimating lens 160. The focusing lens 110 allows an input light signal 100 to be incident and focused thereon. The first optical medium 120 generates terahertz wave 130 using the input light signal that is incident on the focusing lens 110. The second optical medium 140 applies a nonlinear effect (optical rectification) to the input light signal which is used to generate the terahertz wave 130 and is focused by the first optical medium 120, and then generates supercontinuum 150. The collimating lens 160 simultaneously outputs both the terahertz wave 130 and the supercontinuum 150.

A well-known x⁽²⁾ process is represented by equation P(2ω)=x(2ω;ω,+ω)E(ω)E(ω) when there is second harmonic generation (SHG). Another x⁽²⁾ process, a phenomenon P(ω_{THz})=x(ω_{THz};ω,−ω)E(ω)E(ω) known as optical rectification also occurs. Therefore, it can be seen that the terahertz wave is generated by the x⁽²⁾ process. A beam from a single light source (for example, a femtosecond laser) 100 is focused using the focusing lens 110, and the focused beam is incident on the first optical medium (Zinc telluride (ZnTe), Cadmium telluride (CdTe), Diethylaminosulfur trifluoride (DAST), etc.) 120 capable of causing x⁽²⁾ process, and thus the terahertz wave 130 is primarily generated. Further, the second optical medium (optical fiber or nonlinear optical medium) causing a nonlinear effect is located near the focused beam, and thus the supercontinuum 150 is generated. Thereafter, the generated supercontinuum 150 is collimated using the collimating lens 160. Therefore, through the use of the construction of FIG. 1, supercontinuum and terahertz wave can be simultaneously generated using a single light source.

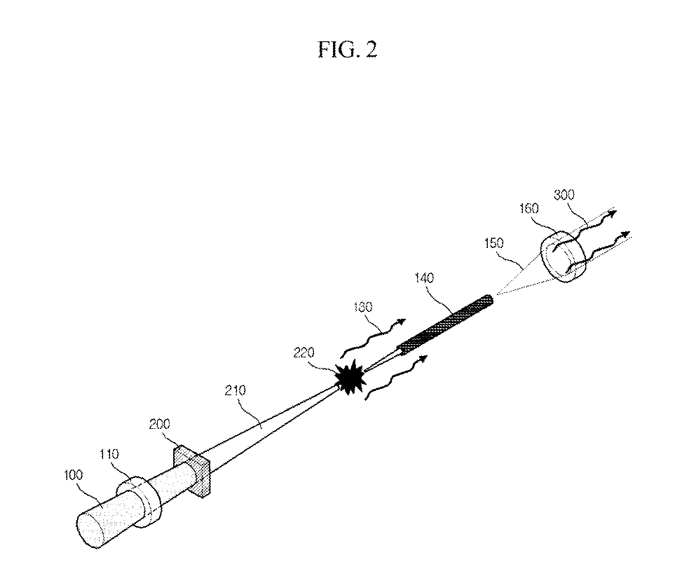

FIG. 2 is a diagram showing another embodiment of the present invention, which illustrates the schematic construction of an apparatus for simultaneously generating terahertz wave based on x⁽³⁾ process and supercontinuum based on nonlinear effect. As shown in FIG. 2, the apparatus for simultaneously generating terahertz wave based on x⁽³⁾ process and supercontinuum based on nonlinear effect according to the present invention includes a focusing lens 110, a first optical medium 200, a second optical medium 140, and a collimating lens 160. The focusing lens 110 allows an input light signal 100 to be incident and focused thereon. The first optical medium 200 generates ω frequency light signal and 2ω frequency light signal using the input light signal that is incident on the focusing lens 110. In this case, the ω and 2ω frequency light signals 210, generated by the first optical medium 200, are focused, and then air plasma 220 is generated. When the air plasma 220 undergoes a reaction, terahertz wave 130 is generated. The second optical medium 140 allows the ω and 2ω frequency light signals 210 to be incident thereon after the terahertz wave 130 has been generated, and then generates supercontinuum 150. The collimating lens 160 simultaneously outputs the terahertz wave 130 and the supercontinuum 150.

In the embodiment of the present invention, the air plasma 220 generated by simultaneously focusing both the ω and 2ω, frequency light signals 210 is a representative of the x⁽³⁾ process. It is well known that the typical principle of the x⁽³⁾ process is based on four-wave mixing (FWM). A beam emitted from a single light source (for example, a femtosecond laser) 100 is focused using the focusing lens 110, and the focused beam is incident on the first optical medium 200 made of a beta-BaB₂O₄ (BBO) or lithium triborate (LiB₃O₅ or LBO) crystal that is capable of causing second harmonic generation (SHG), and thus the ω and 2ω frequency light signals 210 are primarily generated. At the location at which the two signals generated in this way are focused, the air plasma 220 is generated. The terahertz wave 130 based on the x⁽³⁾ process according to the principle of FWM is primarily generated. Further, the second optical medium (an optical fiber and a nonlinear optical medium) 140 causing nonlinear effect is located near the focused beam, and thus supercontinuum 150 is generated using the light signals having two different wavelengths, which are ω and 2ω frequency light signals. Thereafter, the supercontinuum 150, generated in this way, and the terahertz wave 130 are collimated by the collimating lens 160. Therefore, when the construction of FIG. 2 is used, the supercontinuum and the terahertz wave can be simultaneously generated using a single input light signal.

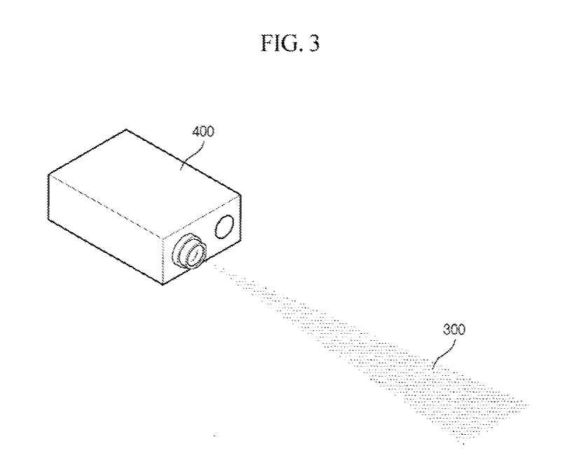

FIG. 3 is a diagram showing a system expected when technical constructions which are desired to be implemented in either of FIGS. 1 and 2 which are two embodiments of the present invention are integrated into a single system. In FIG. 3, the construction of FIG. 1 or 2 is accommodated in a simple small-sized case 400. As shown in the drawing, an integrated system for simultaneously emitting a supercontinuum and a terahertz wave can be developed.

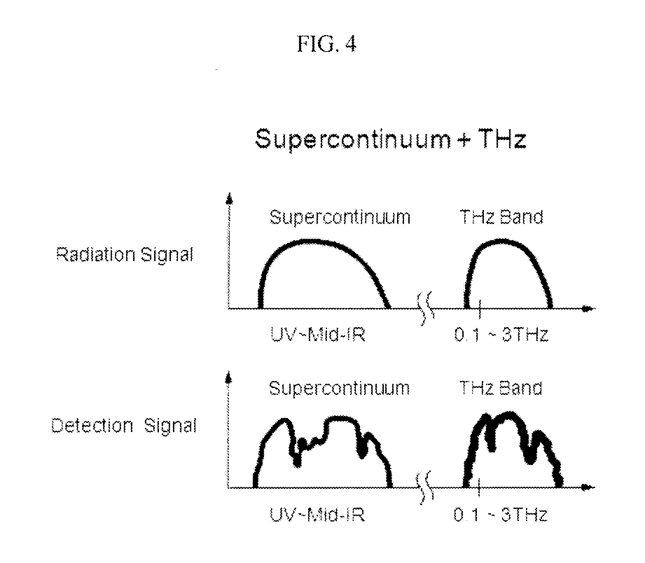

FIG. 4 is a diagram showing applications and effects expected when the technical constructions of either of FIGS. 1 and 2 which are two embodiments of the present invention are integrated. When a radiation signal having bands of both a terahertz wave and a supercontinuum is incident on a medium having unique spectrum peaks, the unique spectrum of the medium desired to be detected in the supercontinuum and the terahertz wave bands can be obtained, as shown in a detected signal. Therefore, two bands rather than one band of either supercontinuum or terahertz wave are simultaneously detected so that a larger number of spectrum peaks can be compared in both IR and terahertz regions, the characteristics of the medium can be analyzed more accurately and efficiently, and the medium which is used can be identified.

For reference, preferred embodiments disclosed in the present specification have been selected as the most preferable embodiments from among various possible embodiments and then presented, for easy understanding of those skilled in the art. It is apparent that the technical spirit of the present invention is not necessarily limited or restricted to the above embodiments, and that various modifications, additions and substitutions are possible, and other equivalent embodiments are also possible, without departing from the scope and spirit of the invention.

As described above, the present invention discloses technology for simultaneously generating a supercontinuum and a terahertz wave. According to the present invention, conventional spectroscopy technology implemented using a single band corresponding to supercontinuum or terahertz wave can be implemented such that measurement is simultaneously performed in two regions, that are Infrared (IR) and terahertz region. Therefore, compared to the conventional technology using a single band, a large amount of spectrum characteristics can be obtained. First, a supercontinuum generation method is added to a well-known terahertz wave generation method (the generation of terahertz wave based on x⁽²⁾ process and the generation of terahertz wave based on x⁽³⁾ process), and thus spectroscopy can be performed simultaneously in two bands (the IR and terahertz bands). Therefore, two bands rather than one band of either supercontinuum or terahertz wave are simultaneously detected, so that a larger number of spectrum peaks can be compared, the characteristics of the medium can be analyzed more accurately and efficiently, and the medium which is used can be identified.

What is claimed is:

1. An apparatus for simultaneously generating a terahertz wave and a supercontinuum, comprising:
a terahertz wave generation unit for generating terahertz wave; and
a supercontinuum generation unit for generating supercontinuum based on a nonlinear effect,
wherein the terahertz wave and the supercontinuum are simultaneously generated using a single input light signal.

2. The apparatus according to claim 1, wherein the terahertz wave generation unit generates terahertz wave based on an x⁽²⁾ process.

3. The apparatus according to claim 2, wherein the terahertz wave generation unit comprises:
a focusing lens for allowing a single input light signal to be incident and focused thereon; and
an optical medium for generating the terahertz wave using the input light signal that is incident on the focusing lens.

4. The apparatus according to claim 3, wherein the optical medium is one of Zinc telluride (ZnTe), Cadmium telluride (CdTe), and Diethylaminosulfur trifluoride (DAST).

5. The apparatus according to claim 1, wherein the terahertz wave generation unit generates the terahertz wave based on an x⁽³⁾ process.

6. The apparatus according to claim 5, wherein the terahertz wave generation unit comprises:
a focusing lens for allowing a single input light signal to be incident and focused thereon; and
an optical medium for generating two light signals having different levels from the input light signal that is incident on the focusing lens.

7. The apparatus according to claim 6, wherein the optical medium is made of beta-BaB₂O₄ (BBO) or lithium triborate (LiB₃O₅ or LBO) capable of causing second harmonic generation (SHG) on the focused input light signal.

8. The apparatus according to claim 6, wherein the two light signals are a light signal having a frequency of ω and a light signal having a frequency of 2ω, respectively.

9. The apparatus according to claim 8, wherein the light signal having the frequency of ω and the light signal having the frequency of 2ω are focused to enable air plasma to be generated, and the terahertz wave is generated when the air plasma undergoes a reaction.

10. The apparatus according to claim 1, wherein the optical medium for generating the supercontinuum is an optical fiber or a nonlinear, optical medium causing a nonlinear effect.

11. The apparatus according to claim 1, wherein the terahertz wave generation unit primarily generates the terahertz wave, the supercontinuum generation unit subsequently generates the supercontinuum, and thus the terahertz wave and the supercontinuum are collimated by a lens.

12. A spectroscopy method, wherein a radiation signal having both bands of the terahertz wave and the supercontinuum generated by the apparatus for simultaneously generating the terahertz wave and the supercontinuum according to claim 1 is incident on a medium having a unique spectrum, and the unique spectrum of the medium desired to be detected is simultaneously obtained in both the bands of the terahertz wave and the supercontinuum.

13. A method of simultaneously generating terahertz wave and supercontinuum, comprising:
allowing a single input light signal to be incident on a focusing lens;
focusing the input light signal, allowing the focused input light signal to be incident on a first optical medium and then generating terahertz wave; and
allowing the input light signal, used to generate the terahertz wave, to be incident on a second optical medium causing nonlinear effect, and then generating supercontinuum.

14. The method according to claim 13, wherein the first optical medium is an optical medium capable of causing an x⁽²⁾ process.

15. The method according to claim 14, wherein the first optical medium is one of Zinc telluride (ZnTe), Cadmium telluride (CdTe), and Diethylaminosulfur trifluoride (DAST).

16. A method of simultaneously generating a terahertz wave and a supercontinuum, comprising:
allowing a single input light signal to be incident on a focusing lens;
focusing the input light signal, allowing the focused input light signal to be incident on a first optical medium, and then generating two light signals having different frequencies;
focusing the two light signals and generating air plasma;
generating terahertz wave when the air plasma undergoes a reaction; and
allowing the light signals, used to generate the terahertz wave, to be incident on a second optical medium causing nonlinear effect, and then generating supercontinuum.

17. The method according to claim 16, wherein the first optical medium is an optical medium capable of causing an x⁽³⁾ process.

18. The method according to claim 16, wherein the first optical medium is made of beta-BaB₂O₄ (BBO) or lithium triborate (LiB₃O₅ or LBO) capable of causing second harmonic generation (SHG) on the focused input light signal.

19. The method according to claim 16, wherein the two light signals having different frequencies are a light signal having a frequency of ω and a light signal having a frequency of 2ω, respectively.

20. The method according to claim 13, wherein the second optical medium for generating the supercontinuum is an optical fiber or a nonlinear optical medium causing a nonlinear effect.

21. The method according to claim 16, wherein the second optical medium for generating the supercontinuum is an optical fiber or a nonlinear optical medium causing a nonlinear effect.
